(19) United States
(12) Patent Application Publication
(10) Pub. No.: US 2022/0204069 A1
(43) Pub. Date: Jun. 30, 2022

(54) INPUT DEVICE

(71) Applicant: KABUSHIKI KAISHA TOKAI RIKA DENKI SEISAKUSHO, Aichi (JP)

(72) Inventor: Yasutaka MATSUDA, Aichi (JP)

(73) Assignee: KABUSHIKI KAISHA TOKAI RIKA DENKI SEISAKUSHO, Aichi (JP)

(21) Appl. No.: 17/507,101

(22) Filed: Oct. 21, 2021

(30) Foreign Application Priority Data
Dec. 25, 2020 (JP) 2020-216998

(51) Int. Cl. B62D 1/04; B60K 35/00

(52) U.S. Cl. CPC B62D 1/046; B60K 2370/141; B60K 2370/1434; B60K 35/00

(57) ABSTRACT

An input device is adapted to be installed in an operation control device equipped with a shaft portion and a grip portion. The shaft portion is configured to be rotatable about an axis extending in a reference direction. The grip portion is adapted to be gripped by a hand of a user and configured to rotate the shaft portion about the axis in accordance with a movement along with a travelling path to perform a steering operation. An operation receiving section is adapted to be disposed between the shaft portion and the grip portion when viewed from the reference direction, and configured to receive an operation with the hand for performing a controlled operation that is different from the steering operation. At least a part of the operation receiving section is adapted to be disposed ahead of a point located rearmost of the grip portion relative to the reference direction.

### FIELD

The presently disclosed subject matter relates to an input device adapted to be installed in an operation control device equipped with a shaft portion and a grip portion. The shaft portion is rotatable about an axis so that the rotation is associated with a controlled operation (an operation to be controlled). The grip portion is configured to rotate the shaft portion by moving along the travelling path. The grip portion has a shape adapted to be gripped by a hand of a user.

### BACKGROUND

Japanese Patent Publication No. 2012-206692A discloses a steering device for changing a traveling direction of a vehicle as the controlled operation. The steering device is equipped with a shaft portion rotatable about a rotation axis, and a gripping portion adapted to be gripped by a driver's hand. The grip portion has an annular shape extending around the rotation axis as a center. The steering device includes an input device configured to receive an operation input from a driver for realizing a controlled operation other than the steering of the vehicle.

### SUMMARY

### Technical Problem

It is demanded to improve the convenience of an input device adapted to be installed in an operation control device equipped with a shaft portion and a grip portion.

### Solution to Problem

In order to meet the demand described above, an illustrative aspect of the presently disclosed subject matter provides an input device adapted to be installed in an operation control device equipped with a shaft portion configured to be rotatable about an axis extending in a reference direction and a grip portion adapted to be gripped by a hand of a user and configured to rotate the shaft portion about the axis in accordance with a movement along with a travelling path to perform a first controlled operation, the input device comprising:

an operation receiving section adapted to be disposed between the shaft portion and the grip portion when viewed from the reference direction, and configured to receive an operation with the hand for performing a second controlled operation that is different from the first controlled operation, wherein at least a part of the operation receiving section is adapted to be disposed ahead of a point located rearmost of the grip portion relative to the reference direction.

When the user performs the first controlled operation, the position of the hand holding the grip portion tends to be changed, so that a part of the hand placed on the grip portion may approach the operation receiving section unintentionally. However, since the operation receiving section is disposed ahead of the point located rearmost of the grip portion relative to the reference direction, it is possible to reduce the possibility that the movement of the hand is received by the operation receiving section as an operation. As a result, it is possible to suppress the occurrence of a situation in which the second controlled operation is unexpectedly executed during the first controlled operation. Accordingly, it is possible to improve the convenience of the input device adapted to be installed in the operation control device equipped with the shaft portion and the grip portion.

### BRIEF DESCRIPTION OF DRAWINGS

FIG. 1 illustrates a configuration of an input device according to one embodiment.

FIG. 2 illustrates a vehicle in which the input device of FIG. 1 is installed.

FIG. 3 illustrates a functional configuration of the input device of FIG. 1.

FIG. 4 illustrates an exemplary configuration of the input device of FIG. 1.

FIG. 5 illustrates another exemplary configuration of the input device of FIG. 1.

### DESCRIPTION OF EMBODIMENTS

Examples of embodiments will be described in detail below with reference to the accompanying drawings. In each of the drawings used in the following description, the scale is appropriately changed in order to make each of the members have a recognizable size.

In the accompanying drawings, an arrow F represents a forward direction of an illustrated structure. An arrow B represents a rearward direction of an illustrated structure. An arrow U represents an upward direction of an illustrated structure. An arrow D represents a downward direction of an illustrated structure. An arrow R represents a right direction of an illustrated structure. An arrow L represents a left direction of an illustrated structure. These directions are specified for the convenience of explanations, and are not intended to limit the direction or posture of the illustrated structure in actual use.

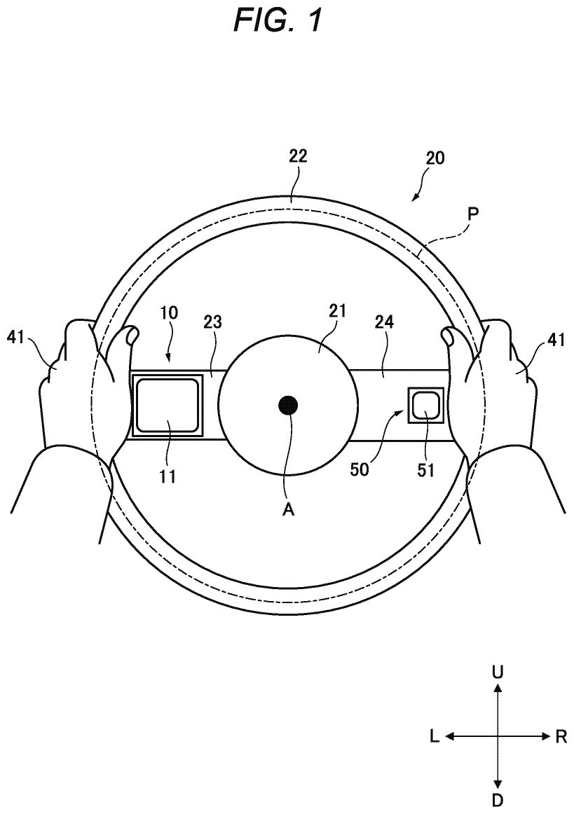

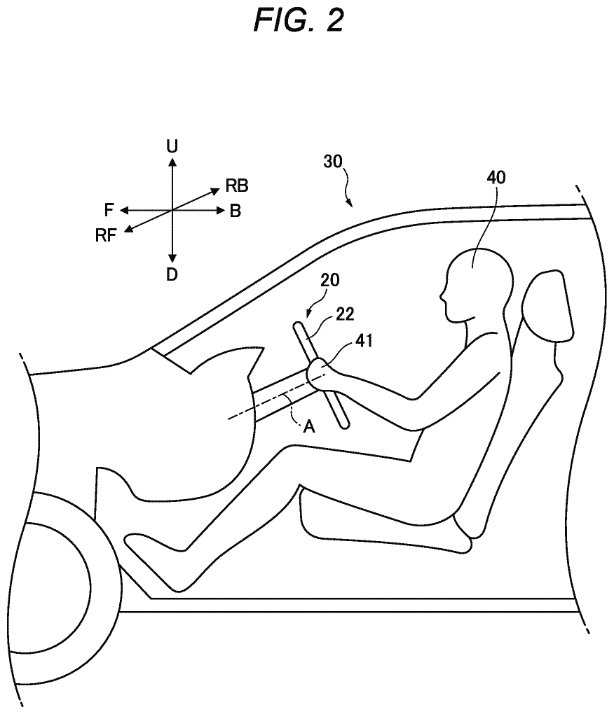

FIG. 1 illustrates an input device 10 according to an embodiment. The input device 10 is installed in a steering device 20. The steering device 20 is a device adapted to be installed in a vehicle 30 illustrated in FIG. 2 and configured to perform a steering operation for changing the traveling direction of the vehicle 30. The steering device 20 is an example of an operation control device. The vehicle 30 is an example of a mobile entity. The steering operation is an example of a first controlled operation.

As illustrated in FIG. 1, the steering device 20 is equipped with a shaft portion 21 and a grip portion 22. The shaft portion 21 is configured to be rotatable about an axis A. The grip portion 22 has an annular shape extending around the axis A as a center. As illustrated in FIG. 2, the grip portion 22 is adapted to be gripped by a hand 41 of a driver 40. The grip portion 22 is configured to be movable along a travelling path P illustrated in FIG. 1 by a hand 41 of a driver 40. The driver 40 is an example of a user.

The steering device 20 includes a left arm portion 23 and a right arm portion 24. The left arm portion 23 and the right arm portion 24 connect the shaft portion 21 and the grip portion 22 to each other. Accordingly, when the grip portion 22 is moved along the travelling path P, the shaft portion 21 is rotated about the axis A. The rotation of the shaft portion 21 in the counterclockwise direction about the axis A is associated with an operation for changing the travelling direction of the vehicle 30 to the left. The rotation of the shaft portion 21 in the clockwise direction about the axis A is associated with an operation for changing the travelling direction of the vehicle 30 to the right.

The input device 10 is disposed on the left arm portion 23 of the steering device 20. The input device 10 includes an operation receiving section 11. The operation receiving section 11 is configured to receive an operation performed with the hand 41 of the driver 40 for executing a controlled operation different from the steering operation. Examples of such a controlled operation include operation control of various devices installed in the vehicle 30. Examples of the various devices include an information display device, an audio-visual device, an air conditioner, and a device for adjusting the position of the steering device 20 or a seat.

When viewed from a direction in which the axis A illustrated in FIG. 2 extends, as illustrated in FIG. 1, the operation receiving section 11 is disposed between the shaft portion 21 and the grip portion 22. In the following descriptions, the direction in which the axis A extends will be referred to as a “reference direction” as required. In FIG. 2, a forward direction and a backward direction relative to the reference direction are represented by an arrow RF and an arrow RB, respectively. The forward direction relative to the reference direction may be different from the forward direction relative to the vehicle 30. Similarly, the backward direction relative to the reference direction may be different from the backward direction relative to the vehicle 30.

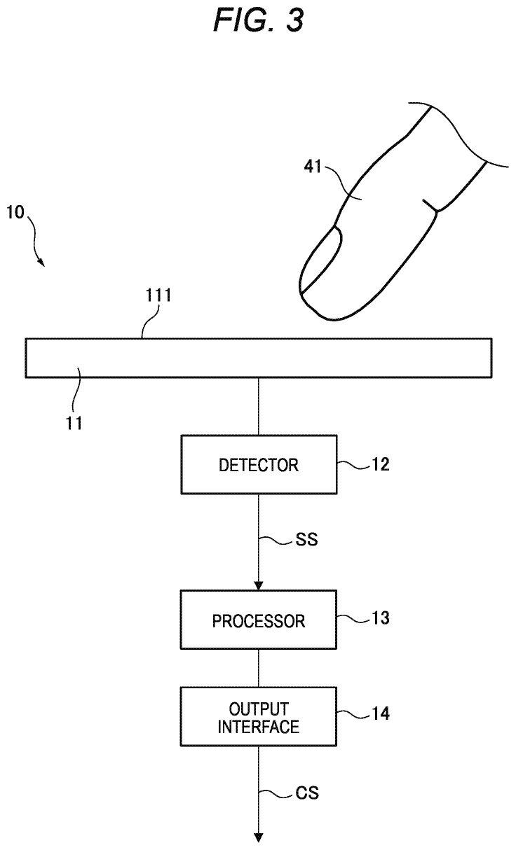

As illustrated in FIG. 3, the input device 10 further includes a detector 12, a processor 13, and an output interface 14.

The operation receiving section 11 includes an operation detecting surface 111. The detector 12 is configured to detect an electrostatic capacitance between the operation detecting surface 111 and the hand 41 of the driver 40.

Although not illustrated, the detector 12 includes a plurality of electrodes and a charging/discharging circuit. The plurality of electrodes are disposed so as to face the operation detecting surface 111. Each of the electrodes is associated with a specific position in the operation detecting surface 111. The charging/discharging circuit can perform a charging operation and a discharging operation. The charging/discharging circuit during the charging operation feeds current supplied from a power source (not illustrated) to each electrode. The charging/discharging circuit during the discharging operation causes each electrode to emit current. An electric field is generated around the operation detecting surface 111 by the current supplied to each electrode. As the hand 41 approaches this electric field, a pseudo capacitor is formed between a particular electrode and the hand 41. As a result, the electrostatic capacitance between the specific electrode and the operation detecting surface 111 is increased. As the electrostatic capacitance increases, the current emitted from the particular electrode during the discharging operation increases.

That is, the detector 12 can detect a position in the operation detecting surface 111 where the hand 41 approaches or contacts by detecting the electrostatic capacitance between the operation detecting surface 111 and the hand 41. The detector 12 is configured to output a detection signal DS indicating a position in the operation detecting surface 111 where the hand 41 approaches or contacts. In other words, the operation detecting surface 111 is used to electrostatically detect the approach or contact of the hand 41.

The processor 13 is configured to determine what kind of operation is inputted to the operation detecting surface 111 based on the detection signal DS outputted from the detector 12. A specific operation performed with respect to the operation detecting surface 111 is associated with a specific controlled operation in advance. The information relating to the association is stored in advance in a storage (not illustrated). By referring to the information, the processor 13 outputs, from the output interface 14, a control signal CS for causing a specific controlled device to perform a controlled operation corresponding to the operation inputted to the operation detecting surface 111. The controlled device executes the controlled operation corresponding to the operation inputted to the operation detecting surface 111 based on the control signal CS.

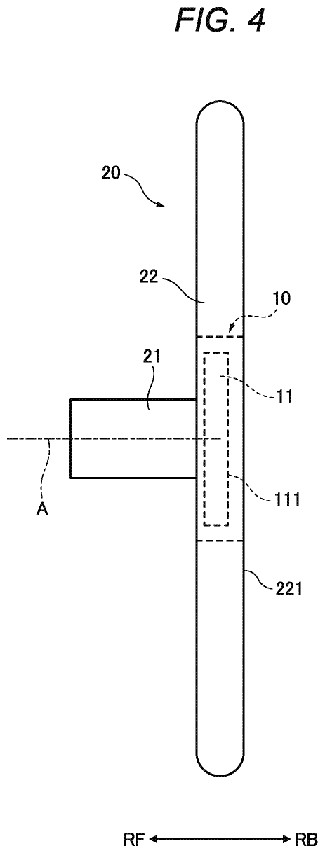

As illustrated in FIG. 4, the grip portion 22 of the steering device 20 has a top face 221. The top face 221 is located closest to the front side as viewed from the driver 40. That is, in this example, the top face 221 is formed as a set of points located rearmost of the grip portion 22 relative to the reference direction.

The operation detecting surface 111 of the input device 10 is disposed ahead of the top face 221 relative to the reference direction. That is, the operation receiving section 11 is disposed ahead of the point located rearmost of the grip portion 22 relative to the reference direction.

When the driver 40 performs the steering operation, the position of the hand 41 holding the grip portion 22 tends to be changed, so that a part of the hand 41 placed on the grip portion 22 may approach the operation receiving section 11 unintentionally. However, since the operation receiving section 11 is disposed ahead of the top face 221 of the grip portion 22 relative to the reference direction, it is possible to reduce the possibility that the movement of the hand 41 is received by the operation receiving section 11 as an operation. As a result, it is possible to suppress the occurrence of a situation in which the controlled operation associated with the operation to be inputted to the operation receiving section 11 is unexpectedly executed during the steering operation. Accordingly, it is possible to improve the convenience of the input device 10 installed in the steering device 20 equipped with the shaft portion 21 and the grip portion 22.

The above advantageous effect is more remarkable particularly in the exemplified configuration in which the approach or contact of the hand 41 of the driver 40 is electrostatically detected, because there is a possibility that an operation input to the operation receiving section 11 may be detected even if the hand 41 does not contact the operation detecting surface 111.

In the above example, the flat operation detecting surface 111 is entirely disposed ahead of the top face 221 of the grip portion 22 relative to the reference direction. However, only a part of the operation detecting surface 111 may be disposed ahead of the top face 221 relative to the reference direction.

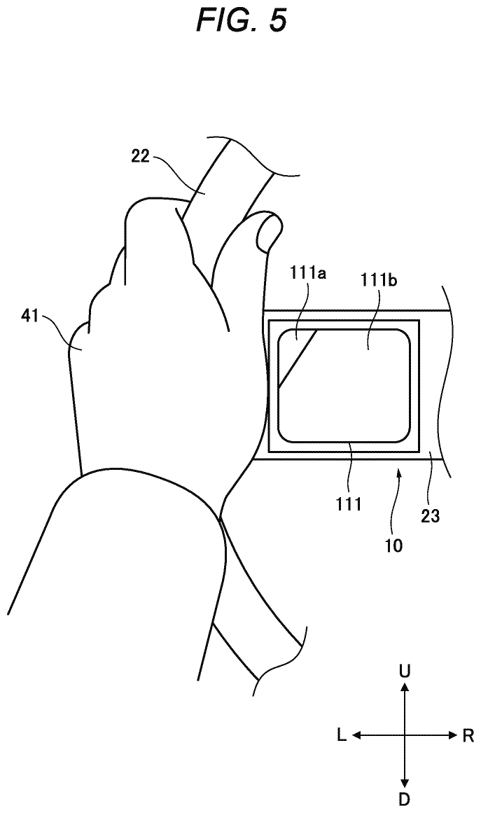

For example, as illustrated in FIG. 5, only an upper left corner portion 111a of the operation detecting surface 111 may be formed to be recessed forward relative to the reference direction from the other portion 111b. That is, only the upper left corner portion 111a can be disposed ahead of the top face 221 of the grip portion 22 relative to the reference direction. The upper left corner portion 111a is an example of an area disposed adjacent to the grip portion 22.

Alternatively, the operation detecting surface 111 formed to be flat entirely may be installed in the steering device 20 so as to be inclined toward the upper left direction so that only the upper left corner portion 111a is disposed ahead of the top face 221 of the grip portion 22 relative to the reference direction.

When a part of the operation receiving section 11 is disposed ahead of the top face 221 of the grip portion 22 relative to the reference direction, the position and size of the part can be appropriately determined in view of both the movement of the hand 41 of the driver 40 assumed during the steering operation and the operability of the input device 10.

In addition to or instead of these examples, the upper left corner portion 111a of the operation detecting surface 111 may be a non-detectable area. The non-detectable area is an area in which the approach or contact of the hand 41 of the driver 40 cannot be electrostatically detected. The non-detectable area may be realized in the hardware basis by not providing the above-described electrodes in the area, or may be realized in the software basis by the processor 13 ignoring the approach or contact of the hand 41 detected in the area.

According to such a configuration, it is possible to further reduce a possibility that an unintended movement of the hand 41 during the steering operation is received by the operation receiving section 11 as an operation input.

The position and size of the non-detectable area can be appropriately determined in view of both the movement of the hand 41 of the driver 40 assumed during the steering operation and the operability of the input device 10.

The configuration of each embodiment described above is merely illustrative for facilitating understanding of the presently disclosed subject matter. The configuration of each embodiment can be appropriately modified or improved without departing from the gist of the presently disclosed subject matter.

In the above embodiment, the operation receiving section 11 is configured to receive an operation input by electrostatically detecting the approach or contact of the hand 41 of the driver 40. However, the operation receiving section may be so configured as to receive an operation input by detecting a mechanical displacement.

For example, as illustrated in FIG. 1, an input device 50 is disposed on the right arm portion 24 of the steering device 20. The input device 50 includes an operation receiving section 51. The operation receiving section 51 may be configured as a switch movable in the reference direction, for example. In this case, when the driver 40 displaces the operation receiving section 51 with the hand 41, the displacement is detected by the detector 12 illustrated in FIG. 3, and is received by the processor 13 as an operation for executing a controlled operation different from the steering operation.

In this example, the operation receiving section 51 is disposed ahead of the top face 221 of the grip portion 22 relative to the reference direction. That is, the operation receiving section 51 is disposed ahead of the point located rearmost of the grip portion 22 relative to the reference direction.

According to the configuration of the present example, since it is possible to reduce the possibility that the hand 41 of the driver 40 unintentionally displaces the operation receiving section 51 during the steering operation, it is possible to suppress the occurrence of a situation in which the controlled operation associated with the operation to be inputted to the operation receiving section 51 is unexpectedly executed during the steering operation.

It should be noted that a configuration for electrostatically detecting the approach or contact of the hand 41 of the driver 40 can be combined with the operation receiving section 51 configured to involve the mechanical displacement. For example, a surface (top face) located rearmost of the operation receiving section 51 relative to the reference direction may be configured to serve in the same manner as the above-described operation detecting surface 111.

In the above embodiment, the grip portion 22 has an annular shape extending around the axis A as a center. However, the shapes of the grip portion 22 and the traveling path P can be appropriately determined as long as the grip portion 22 has a portion adapted to be gripped by the hand 41 of the driver 40 and is capable of rotating the shaft portion 21 about the axis A in accordance with the movement along the travelling path P. For example, the grip portion 22 may be an annulus having an oval shape or a rectangular shape. Alternatively, the grip portion 22 may have a shape in which a portion adapted to be gripped by a left hand and a portion adapted to be gripped by a right hand are independent of each other.

The input device 10 may be installed in a steering device for changing the travelling direction of a mobile entity other than the vehicle 30. Examples of such mobile entities include railways, ships, and aircrafts.

The input device 10 need not be installed in a steering device of a mobile entity. For example, the input device 10 may be installed in a controller for controlling the movement of an object displayed on a display of a shooting game device in an amusement facility. The operation receiving section 11 can be used to receive an operation from a player for causing the object to perform an operation of causing the object to emit a weapon. In this case, the controller is an example of the operation control device. The movement of the object is an example of the first controlled operation. The operation of causing the object to emit a weapon is an example of a second controlled operation. The player is an example of the user.

The present application is based on Japanese Patent Application No. 2020-216998 filed on Dec. 25, 2020, the entire contents of which are incorporated herein by reference.

What is claimed is:

1. An input device adapted to be installed in an operation control device equipped with a shaft portion configured to be rotatable about an axis extending in a reference direction and a grip portion adapted to be gripped by a hand of a user and configured to rotate the shaft portion about the axis in accordance with a movement along with a travelling path to perform a first controlled operation, the input device comprising:
an operation receiving section adapted to be disposed between the shaft portion and the grip portion when viewed from the reference direction, and configured to receive an operation with the hand for performing a second controlled operation that is different from the first controlled operation,
wherein at least a part of the operation receiving section is adapted to be disposed ahead of a point located rearmost of the grip portion relative to the reference direction.

2. The input device according to claim 1,
wherein the operation receiving section includes an operation detecting surface adapted to be used to electrostatically detect approach or contact of the hand; and
wherein at least a part of the operation detecting surface is adapted to be disposed ahead of the point located rearmost of the grip portion relative to the reference direction.

3. The input device according to claim 2,
wherein the operation detecting surface is flat.

4. The input device according to claim 2,
wherein a part of the operation detecting surface is configured to be an area that is not capable of detect the approach or contact of the hand electrostatically.

5. The input device according to claim 1,
wherein the first controlled operation is an operation for changing a travelling direction of a mobile entity.
